(19) United States
(12) Patent Application Publication
(10) Pub. No.: US 2026/0023855 A1
(43) Pub. Date: Jan. 22, 2026

(54) FIELD SYSTEM

(71) Applicant: SCHLUMBERGER TECHNOLOGY CORPORATION, Sugar Land, TX (US)

(72) Inventors: Anh DANG, Sugar Land, TX (US); Nirina RAVELOSON, Petaling Jaya (MY)

(21) Appl. No.: 19/116,923

(22) PCT Filed: Sep. 29, 2023
(86) PCT No.: PCT/US2023/075488

§ 371 Date: Mar. 28, 2025

Related U.S. Application Data
(60) Provisional application No. 63/411,760, filed on Sep. 30, 2022.

(51) Int. Cl. G06F 21/57; G06F 11/14; G06F 21/53; G06F 21/60

(52) U.S. Cl. CPC G06F 21/575; G06F 11/1433; G06F 21/53; G06F 21/572; G06F 21/602

(57) ABSTRACT

A method can include operating a field system using a first partition as an active partition and a second partition as a passive partition; responsive to receipt of a system update, changing a bootloader configuration from the first partition to the second partition; performing root of trust measurements for the update where the measurements account at least for the change in the bootloader configuration; responsive to establishing trust via the measurements, accessing an encryption key; decrypting, using the encryption key, at least the second partition for use by the system; and rebooting the field system using the second partition as an active partition and the first partition as a passive partition for a system rollback responsive to detection of a system update issue.

### RELATED APPLICATIONS

This application claims priority to and the benefit of a US Provisional Application having Ser. No. 63/411,760, filed 30 Sep. 2022, which is incorporated by reference herein in its entirety.

### BACKGROUND

A field system can include one or more of various types of field equipment that can be used at field sites. For example, consider a flow meter that can measure flow rates of fluid at a wellsite. In such an example, the flow meter can include or be operatively coupled to a microcontroller such as a processor with associated memory that can store instructions for execution by the microcontroller to perform one or more tasks.

### SUMMARY

A method can include operating a field system using a first partition as an active partition and a second partition as a passive partition; responsive to receipt of a system update, changing a bootloader configuration from the first partition to the second partition; performing root of trust measurements for the update where the measurements account at least for the change in the bootloader configuration; responsive to establishing trust via the measurements, accessing an encryption key; decrypting, using the encryption key, at least the second partition for use by the system; and rebooting the field system using the second partition as an active partition and the first partition as a passive partition for a system rollback responsive to detection of a system update issue. A system can include one or more processors; memory accessible to at least one of the one or more processors; processor-executable instructions stored in the memory and executable to instruct the system to: operate a field system using a first partition as an active partition and a second partition as a passive partition; responsive to receipt of a system update, change a bootloader configuration from the first partition to the second partition; perform root of trust measurements for the update where the measurements account at least for the change in the bootloader configuration; responsive to establishment of trust, access an encryption key; decrypt, using the encryption key, at least the second partition for use by the system; and reboot the field system using the second partition as an active partition and the first partition as a passive partition for a system rollback responsive to detection of a system update issue. One or more computer-readable storage media can include processor-executable instructions to instruct a computing system to: operate a field system using a first partition as an active partition and a second partition as a passive partition; responsive to receipt of a system update, change a bootloader configuration from the first partition to the second partition; perform root of trust measurements for the update where the measurements account at least for the change in the bootloader configuration; responsive to establishment of trust, access an encryption key; decrypt, using the encryption key, at least the second partition for use by the system; and reboot the field system using the second partition as an active partition and the first partition as a passive partition for a system rollback responsive to detection of a system update issue. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system;

FIG. 2 illustrates examples of systems;

FIG. 3 illustrates an example of a system;

FIG. 4 illustrates an example of a system;

FIG. 5 illustrates an example of a system;

FIG. 6 illustrates an example of a system;

FIG. 7 illustrates examples of workflows;

FIG. 8 illustrates an example of a workflow;

FIG. 9 illustrates an example of a method;

FIG. 10 illustrates an example of a controller; and

FIG. 11 illustrates examples of computer and network equipment.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

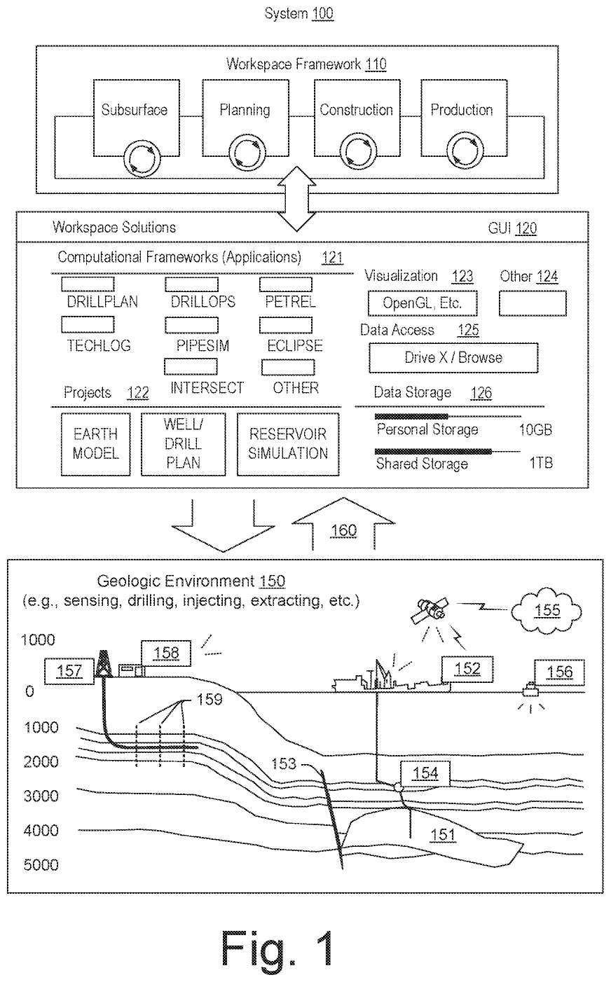

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, predictors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, predicting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, DRILLOPS, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (Al) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. In such an approach, one or more features of a framework that may be available in one language may be accessed via a converter. For example, consider the APACHE SPARK framework that can include features available in a particular language where a converter may convert code in another language to that particular language such that one or more of the features can be utilized. As an example, a production field may include various types of equipment, be operable with various frameworks, etc., where one or more languages may be utilized. In such an example, a converter may provide for feature flexibility and/or compatibility.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

While several simulators are illustrated in the example of FIG. 1, one or more other simulators may be utilized, additionally or alternatively. For example, consider the VISAGE geomechanics simulator (SLB, Houston Texas) or the PETROMOD simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

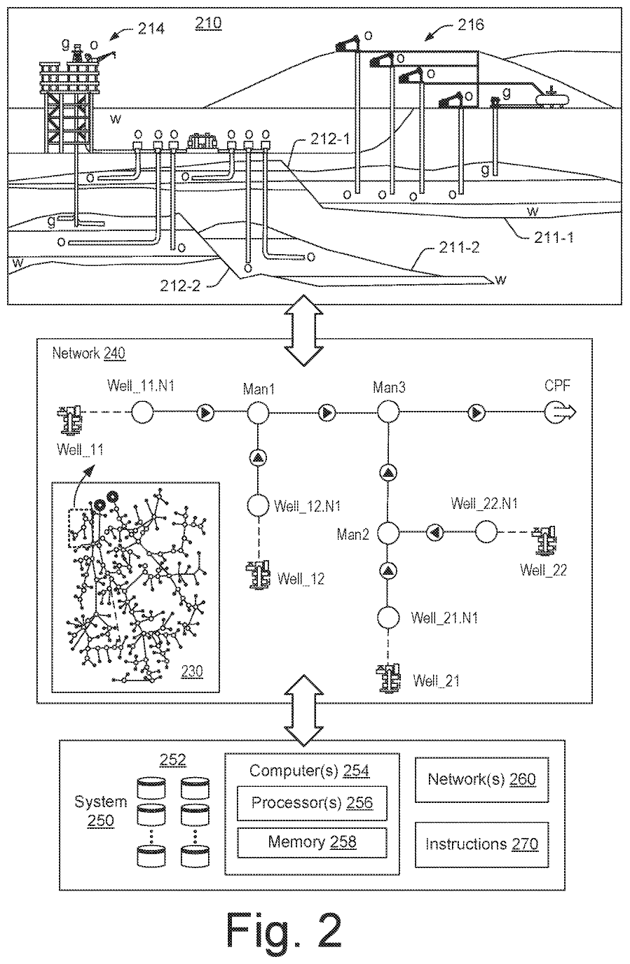

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example of FIG. 2, the geologic environment 210 can include fluids such as oil (o), water (w) and gas (g), which may be stratified in the reservoirs 211-1 and 211-2.

In the example of FIG. 2, the equipment 214 and 216 can include one or more of drilling equipment, wireline equipment, production equipment, etc. For example, consider the equipment 214 as including a drilling rig that can drill into a formation to reach a reservoir target where a well can be completed for production of hydrocarbons. As an example, the equipment 216 can include production equipment such as wellheads, valves, pump equipment, gas handling equipment, separators, flow meters, etc. As an example, one or more features of the system 100 of FIG. 1 may be utilized for operations in the geologic environment 210. For example, consider utilizing a drilling or well plan framework, a drilling execution framework, a production framework, etc., to plan, execute, etc., one or more drilling operations, production operations, etc.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of fluid (e.g., oil, water and/or gas) from well locations along flowlines interconnected at junctions with final delivery at a central processing facility (CPF). Where fluid includes solids (e.g., sand, etc.), one or more pieces of equipment may provide for solids removal, collection, etc.

In the example of FIG. 2, various portions of the network 240 may include conduit. For example, consider a perspective view of a geologic environment that includes two conduits which may be a conduit to Man1 and a conduit to Man3 in the network 240, where Man1, Man2 and Man3 are manifolds.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or other modeling. As an example, one or more methods, techniques, etc. may be performed using one or more sets of instructions, which may be, for example, the instructions 270 of FIG. 2.

As an example, various graphics in FIG. 2 may be part of a graphical user interface (GUI) that can be generated using executable instructions that may be executable locally and/or remotely using local and/or remote display devices (e.g., a mobile device, a workstation, etc.).

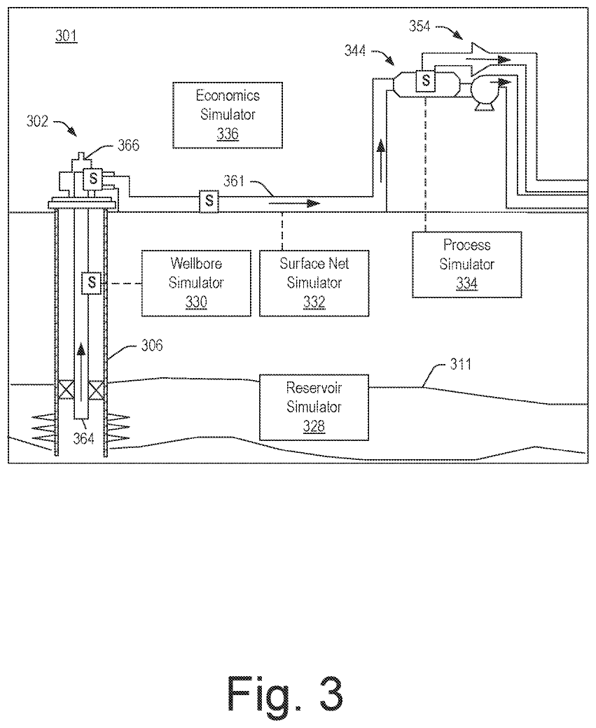

FIG. 3 shows an example of portion of a geologic environment 301 that can include various types of equipment. As shown in FIG. 3, the environment 301 can include a wellsite 302 and a fluid network 344. In the example of FIG. 3, the wellsite 302 includes a wellbore 306 extending into earth as completed and prepared for production of fluid from a reservoir 311.

In the example of FIG. 3, wellbore production equipment 364 extends from a wellhead 366 of the wellsite 302 and to the reservoir 311 to draw fluid to the surface. As shown, the wellsite 302 is operatively connected to the fluid network 344 via a transport line 361. As indicated by various arrows, fluid can flow from the reservoir 311, through the wellbore 306 and onto the fluid network 344. Fluid can then flow from the fluid network 344, for example, to one or more fluid processing facilities.

In the example of FIG. 3, sensors(S) are located, for example, to monitor various parameters during operations. The sensors(S) may measure, for example, pressure, temperature, flowrate, composition, and other parameters of the reservoir, wellbore, gathering network, process facilities and/or other portions of an operation. As an example, the sensors(S) may be operatively connected to a surface unit (e.g., to instruct the sensors to acquire data, to collect data from the sensors, etc.).

In the example of FIG. 3, a surface unit can include computer facilities, such as a memory device, a controller, one or more processors, and a display unit (e.g., for managing data, visualizing results of an analysis, etc.). As an example, data may be collected in the memory device and processed by the processor(s) (e.g., for analysis, etc.). As an example, data may be collected from the sensors(S) and/or by one or more other sources. For example, data may be supplemented by historical data collected from other operations, user inputs, etc. As an example, analyzed data may be used to in a decision making process.

As an example, a transceiver may be provided to allow communications between a surface unit and one or more pieces of equipment in the environment 301. For example, a controller may be used to actuate mechanisms in the environment 301 via the transceiver, optionally based on one or more decisions of a decision making process. In such a manner, equipment in the environment 301 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit or other unit, system, etc.). As an example, data fed into one or more simulators may be historical data, real time data or combinations thereof. As an example, simulation through one or more simulators may be repeated or adjusted based on the data received.

In the example of FIG. 3, simulators can include a reservoir simulator 328, a wellbore simulator 330, a surface network simulator 332, a process simulator 334 and an economics simulator 336. As an example, the reservoir simulator 328 may be configured to solve for hydrocarbon flow rate through a reservoir and into one or more wellbores. As an example, the wellbore simulator 330 and surface network simulator 332 may be configured to solve for hydrocarbon flow rate through a wellbore and a surface gathering network of pipelines. As to the process simulator 334, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 336 may be configured to model costs associated with at least part of an operation. For example, consider the MERAK framework (SLB, Houston, Texas), which may provide for economic analyses.

As an example, a system can include and/or be operatively coupled to one or more of the simulators 328, 330, 332, 334 and 336 of FIG. 3. As an example, such simulators may be associated with frameworks and/or may be considered tools (see, e.g., the system 100 of FIG. 1, etc.). Various pieces of equipment in the example geologic environment 301 of FIG. 3 may be operatively coupled to one or more systems, one or more frameworks, etc. As an example, one or more of the sensors(S) may be operatively coupled to one or more networks (e.g., wired and/or wireless) for transmission of data, which, as explained, may include data indicative of production. As shown, a sensor(S) may be utilized for acquisition of downhole data and/or surface data, which can include data relevant to production (e.g., flow rate, temperature, pressure, composition, etc.). Such data may be utilized in a system such as, for example, the system 100 of FIG. 1 for operational decision making, etc.

As an example, a system may utilize one or more cloud services for performing various tasks where the cloud services can be in communication with local services at a wellsite or wellsites. As an example, various features may be local and/or remote. As an example, a system can include and/or utilize features of one or more cloud platforms (e.g., GOOGLE CLOUD, AMAZON WEB SERVICES CLOUD, AZURE CLOUD, etc.). As an example, the DELFI cognitive exploration and production (E&P) environment may be implemented at least in part in a cloud platform.

As an example, a system may provide for various types of simulations such as, for example, reservoir simulation, wellbore simulation, surface network simulation, integrated simulation, etc. As an example, field equipment can include sensors that can acquire measurements where such measurements may be utilized locally and/or remotely. For example, consider measurements that can be obtained for derived flow rate, proxy models, simulation models, etc.

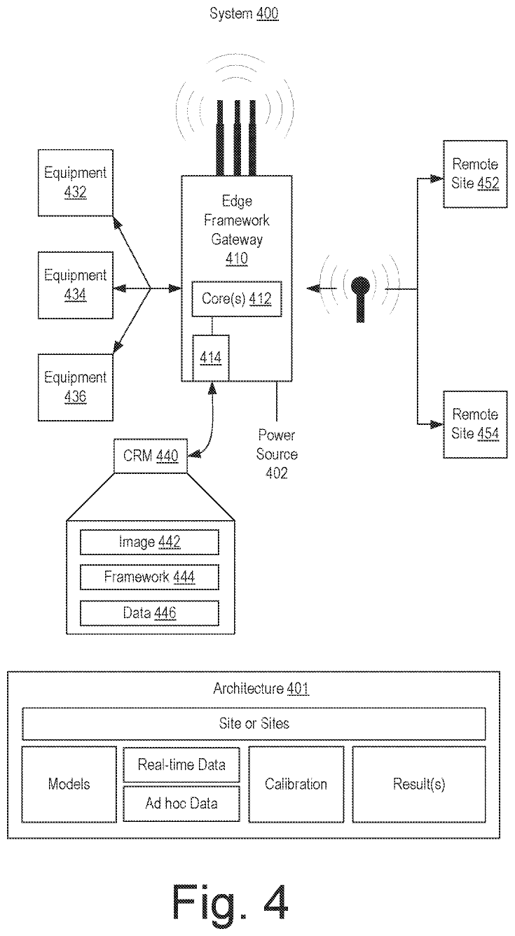

FIG. 4 shows an example of a system 400 and an example of an architecture 401. As shown, the architecture 401 can provide services for one or more sites. For example, the architecture 401 can generate one or more results (e.g., control actions, etc.) that can be utilized for field operations. In such an example, the result or results may be generated locally and/or remotely (e.g., depending on number of sites, resources, etc.). As shown, the architecture 401 can include one or more models. The architecture 401 may include one or more physics models, one or more machine learning models, etc. As shown, the architecture 401 includes an interface for real time data, optionally an interface for ad hoc data, and a calibration component. The result(s) component may include a result interface where an output result can be a control trigger, a control instruction, etc., that can call for an action or actions by a piece or pieces of equipment.

As shown, the system 400 can include a power source 402 (e.g., solar, generator, grid, etc.) that can provide power to an edge framework gateway 410 that can include one or more computing cores 412 and one or more media interfaces 414 that can, for example, receive a computer-readable medium 440 that may include one or more data structures such as an image 442, a framework 444 and data 446. In such an example, the image 442 may be an operating system image that can cause one or more of the one or more cores 412 to establish an operating system environment that is suitable for execution of one or more applications. For example, the framework 444 may be an application suitable for execution in an established operating system in the edge framework gateway 410. As an example, the framework 444 may be suitable for performing tasks associated with the architecture 401. For example, consider tasks associated with utilization of one or more models, setting one or more parameters, generating one or more results based at least in part on one or more models, etc.

In the example of FIG. 4, the edge framework gateway 410 (“EF”) can include one or more types of interfaces suitable for receipt and/or transmission of information. For example, consider one or more wireless interfaces that may provide for local communications at a site such as to one or more pieces of local equipment 432, 434 and 436 and/or remote communications to one or more remote sites 452 and 454. As an example, the local equipment 432, 434 and 436 can include one or more sensors.

As an example, the EF 410 may be installed at a site that is some distance from a city, a town, etc. In such an example, the EF 410 may be accessible via a satellite communication network.

A communications satellite is an artificial satellite that relays and amplifies radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite.

High frequency radio waves used for telecommunications links travel by line-of-sight, which may be obstructed by the curve of the Earth. Communications satellites can relay signal around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency. As shown in the example of FIG. 4, the EF 410 may be deployed where it can operate locally with one or more pieces of equipment 432, 434, 436, etc., which may be for purposes of control.

As desired, from time to time, communication may occur between the EF 410 and one or more remote sites 452, 454, etc., which may be via satellite communication where latency and costs are tolerable. As an example, the CRM 440 may be a removable drive that can be brought to a site via one or more modes of transport. For example, consider an air drop, a human via helicopter, plane or boat, etc.

As to an air drop, consider dropping an electronic device that can be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF 410. Such an approach can provide for local control where one or more humans may or may not be present at the site. As an example, an autonomous and/or human controllable vehicle at a site may help to locate an electronic device and help to download its payload to an EF such as the EF 410. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As an example, a system may include and/or provide access to various resources that may be part of an environment such as, for example, the DELFI environment (see, e.g., FIG. 1). For example, consider the PIPESIM framework, which may be implemented locally and/or remotely (e.g., as a full and/or as a tailored framework). As an example, the PIPESIM framework and/or other framework may be utilized for one or more purposes, which may include calibration, generation of results, etc. As an example, a framework such as the PIPESIM framework may provide for comparisons between output of a semi-empirical model or models and output of the PIPESIM framework.

As an example, an EF may include a license server, a semi-empirical model(s) component, a framework simulation engine (e.g., a PIPESIM engine, etc.) and a REST API where the REST API can receive one or more API calls, for example, as one or more model requests, calibration requests, simulation requests, etc. As an example, an EF may respond to an API call with output where such output may be provided to one or more edge applications, pieces of equipment, etc. (e.g., for individual and/or coordinated control of one or more sets of equipment, etc.).

Referring again to the architecture 401, as explained, one or more physics based models can be deployed to an edge for implementation, for example, to operate responsive to real-time data for one or more types of equipment control. As an example, a fluid simulation framework such as the PIPESIM framework may be implemented in an edge manner. Such a fluid simulation framework can be a multiphase flow simulation framework suitable for handling multiphase flow that may occur in one or more types of oil and/or gas field operations.

As an example, one or more types of frameworks may be utilized for a virtual flow meter (VFM). For example, a framework can include sets of conservation equations for mass momentum and energy describing single, two or three phase flow (e.g., according to one or more of a LEDAFLOW (Kongsberg Oil & Gas Technologies AS, Sandvika, Norway), OLGA model (SLB, Houston, Texas), TUFFP unified mechanistic models (Tulsa University Fluid Flow Projects, Tulsa, Oklahoma), etc.). As an example, a framework can include a simulator such that flow simulation can be performed, which may be for multiphase fluid flow.

As shown in FIG. 4, an EF may execute within a gateway such as, for example, an AGORA gateway (e.g., consider one or more processors, memory, etc., which may be deployed as a “box” that can be locally powered and that can communicate locally with other equipment via one or more interfaces). As an example, a gateway can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., approximately 25 cm×20.3 cm×10.2 cm).

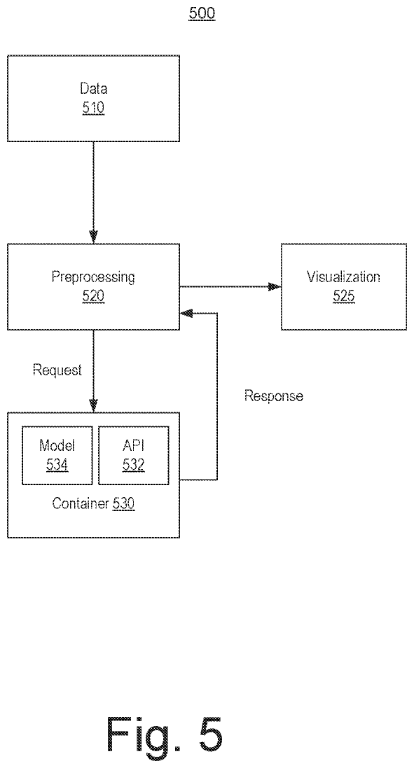

FIG. 5 shows an example of a system 500 that includes components for data acquisition 510, data preprocessing 520, optional data visualization 525, and generation of output (e.g., a result or results) 530, which can be implemented using a containerized application programming interface (API) 532 for access to a model 534 (e.g., a physics-based model, a trained machine learning model, etc.). As shown, an edge application architecture can be utilized where a suitable language or languages may be implemented (e.g., JSON, etc.). In the example of FIG. 5, the system 500 can preprocess data where API calls may be in the form of JSON requests where JSON responses may be received. In the example of FIG. 5, the system 500 can include one or more edge applications and one or more types of components (e.g., containerized, etc.) that may be accessed using one or more APIs.

As an example, one or more features of the system 400 of FIG. 4, the system 500 of FIG. 5, etc., may be amenable to being updated where, for example, an update may be communicated to the system 400 or the system 500 via one or more techniques, one or more technologies, etc. As an example, an update may be provided using one or more security techniques and/or one or more security technologies. For example, an update may be encrypted, transmitted via a secure network, etc. As an example, an update may be subjected to multifactor authentication (MFA), which may be layered as to access to a field system, transmission to a field system, decryption of an encrypted update at a field system, etc. As an example, an update may have an associated metric or metrics (e.g., a hash, a certificate, etc.).

As an example, an update may be directed to a single system (e.g., a single field gateway) and/or to a number of systems (e.g., multiple field gateways). As an example, where a field includes a number of systems, which may be associated with a number of wells, updates may be rolled out for the number of systems in a coordinated manner. For example, consider rollout in parallel, in series, in parallel and in series, etc. As an example, an update may be rolled out to one or more field systems where, upon successful installation, the update may be rolled out to one or more additional field systems. As an example, reporting of status from a number of systems may be utilized to coordinate updates.

As explained, field equipment can include computational resources that can provide for execution of instructions. Such instructions may include BIOS instructions, operating system (OS) instructions, application instructions, etc. As explained, field equipment such as a gateway can include a TPM, which may provide for secure and measured boot support. As field equipment may be located in a remote location where operators may visit infrequently, the field equipment can provide some assurances for robust operation. For example, consider a case or shelter to protect equipment from environmental conditions such as rain, snow, sun, sand, lightening, wind, etc. Robust operation can be desirable to reduce non-productive time (NPT) such that tasks can be performed reliably in a continuous manner, a periodic manner and/or an on-demand manner.

In various instances, downtime of a gateway may occur for an update, which may aim to update instructions, which may include instructions for a parameter update, a model update, a BIOS update, an OS update, an application update, an API update, a container update, etc. Further, if an update is unsuccessful, additional downtime may occur, which may result in suboptimal field operations such as, for example, production of fluid being less than planned, lack of data acquisition and/or processing, etc.

As explained, a gateway can be part of an IoT infrastructure that can be deployed at a wellsite to interact with field equipment. As explained, a gateway may be part of infrastructure to acquire data and transmit such data, whether raw or processed, to a cloud backend, which may provide for data analytics, remote monitoring, remote control, etc.

Where a gateway is operatively coupled to a network or networks, cybersecurity concerns can arise. For example, if a gateway is compromised via malicious network activity, there may be an impact on field operations. As to cybersecurity protections, a program may aim to meet various security requirements. For example, consider requirements such as system integrity, data confidentiality and an ability to perform a secure update with fail-safe rollback.

As to system integrity, an industrial IoT (IIoT) gateway can be deployed in a remote area where physical security protection is not available. This could lead to a system tampering attack where someone who has physical access to the IIoT gateway can maliciously modify its instructions in a manner that can negatively impact field operations. Operation integrity can focus on system integrity protection where the system has the capability to detect and prevent a system tampering attack. As explained, circuitry such as a TPM may be included in a gateway that can provide hardware-based root of trust operations.

As to data confidentiality, an IIoT gateway can connect to field equipment to acquire data and transmit such data to a cloud backend, whether raw and/or processed. In various instances, data may be stored on a gateway storage device, which may be in an encrypted form. For example, a TPM may provide one or more encryption technologies for encrypting and optionally decrypting data.

As to secure update with a fail-safe rollback mechanism, to maintain the security posture of an IIoT gateway, a system can provide for delivery and application of secure patches (e.g., updates) on a field deployed IIoT gateway from time to time, which may aim to address system demands, improvements and/or identified and/or potential security vulnerabilities. As noted, secure updates may be provided along with a fail-safe rollback mechanism, which, for example, may aim to reduce downtime associated with a corrupted system, for example, as may occur for an update failure.

As an example, a gateway can include features that can implement appropriate cybersecurity measures, particularly for secure updates along with fail-safe rollback.

As to various aspects of system integrity and data confidentiality, a published US Patent Application is incorporated by reference herein, entitled “Industrial internet of things gateway boot methods”, with publication number US 2021/0011734 A1, as published on 14 Jan. 2021, referred to herein as the '734 application.

As mentioned, a gateway can include a TPM as a type of crypto processor to securely store one or more algorithms, artifacts, etc., that can be used for one or more purposes. For example, a TPM can be utilized to authenticate a hardware platform for a measured boot process and/or a secure boot process. As to artifacts, these may include passwords, certificates and/or one or more encryption keys. As an example, a TPM can be used to store measurements that can help ensure that a system remains trustworthy.

As an example, a TPM can provide for taking measurements of certain pieces of code and/or activities of a system. For example, consider measurements that may be computing hashes of code fragments, measuring speed for which certain operations are executed, computing a hash via an algorithm using certain characteristic values from machine different specific items, like serial numbers, MAC addresses, etc. As an example, a TPM can include a co-processor that handles cryptographic operations such as asymmetric key generation (RSA), asymmetric encryption/decryption (RSA), hashing (e.g., Secure Hash Algorithm (SHA-1), etc.), and random number generation (RNG).

As an example, a TPM can include a hardware random number generator, facilities for the secure generation of cryptographic keys for limited uses, features for remote attestation (e.g., creation of a hash summary of a hardware and software configuration that may be used to verify that the hardware and software have not been changed), features for binding (e.g., encryption of data using a bind key, a unique RSA key descended from a storage key where a master wrapping key, referred to as a storage root key, can be stored within the TPM), and features for sealing (e.g., specifying a TPM state for data to be decrypted (unsealed)).

As an example, a system may include user-level RSA key containers that may be stored with an OS user profile for a particular user for use to encrypt and decrypt information for applications that run under that specific user identity.

As an example, a TPM can include platform configuration registers (PCRs) that can store measurements, which may be in the form of a digest generated by an associated hashing algorithm.

As mentioned, a TPM can be utilized to perform a root of trust (RoT) process that can help to ensure integrity. A RoT process can help to assure, for example, that a boot process starts from a trusted combination of hardware and software, and continues until an OS has fully booted and applications are running.

As an example, a boot process can utilize a hardware platform that includes a processor and a TPM where the TPM includes PCRs as secure registers. During a boot process, ROT measurement code and BIOS code components can be executed with assurances from the TPM. For example, a TPM can “measure” code by storing values in PCRs. An approach can utilize a so-called “extend” function that hashes a stored value and a code value and stores the result in a PCR. For example, a PCR may store SHA-1 (value1∥value2) where value1 is a SHA-1 hash of a code value and value2 is a code value concatenated to value1. The concatenated value is SHA-1 hashed and stored to the PCR. A log may also be generated that corresponds to operations performed by the TPM, for example, as TPM code calls for measurement of a BIOS code component, as the BIOS code component calls for measurement of another code component, etc.

In various TPMs, PCRs can be changed by a reboot function, which clears the PCRs, and by an extend function, which may concatenate a number and a hash stored in a PCR, hash the concatenation and store the resulting hash in the PCR. In general, there is no other way for a system to change the value of a PCR.

As explained, a TPM can include PCRs that can store hashes that can be read where such hashes are written to the PCRs via an extend function, which, as explained, can depend on a previous hash value to form a type of blockchain. The PCRs can be used for platform hardware and software integrity checking between boots (e.g., protection against Evil Maid attack). PCRs can also be used to unlock one or more encryption keys and proving that a proper OS was booted.

One or more of various different TPM specifications may be utilized (e.g., 1.2, 2.0, etc.). As an example, a BIOS-based system may use the TPM 1.2 specification. As an example, the TPM 2.0 specifications can operate with a Unified Extensible Firmware Interface (UEFI) to use a TPM to form a root of trust. As explained, a TPM can be utilized in a manner where PCRs allow secure storage and reporting of security-relevant metrics where such metrics can be used to detect changes to a previous configuration and, for example, decide how to proceed.

For a LINUX system, the LINUX Unified Key Setup (LUKS) may be utilized, which is a disk encryption specification. LUKS can be used to encrypt a block device. The contents of an encrypted device can be arbitrary, and therefore any file system (fs or FS) can be encrypted. Per LUKS, there can be an unencrypted header at the beginning of an encrypted volume, which may allow up to 8 (LUKS1) or 32 (LUKS2) encryption keys to be stored along with encryption parameters such as cipher type and key size.

As an example, a method can include unlocking a LUKS volume using a TPM (e.g., consider Clevis, #systemd-cryptenroll, etc.). As an example, an encrypted volume or volumes may be unlocked using one or more keys stored in a TPM, which may occur automatically at boot, for example, depending on one or more conditions. As an example, in some instances, a manual approach may be utilized after boot. Using a TPM for this purpose can help to ensure that a drive or drives (e.g., one or more partitions) will not unlock unless certain conditions are met. A condition can be a code (e.g., instructions) condition, a configuration condition, etc.

As an example, one or more drives, one or more volumes and/or one or more partitions may be utilized. The term volume may be used to describe a storage device such as a drive, though it may also be used to refer to a part of a storage device (e.g., via splitting storage up into chunks). A system may make storage accessible via a file system in a process referred to as mounting. As an example, a mounted volume or volumes may be one or more devices (e.g., hard drives, USB drives, DVD-RWs, SD cards, other media, etc.). If a volume is currently mounted, it may be read and possibly written to. As an example, the term partition can refer to a physical area of storage, which may be on a single storage device; however, as explained, partitions may be utilized in a manner where the partitions are on a number of storage devices (e.g., one partition on one storage device and another partition on another storage device). As an example, a partition may be mounted and may, for example, be referred to as a volume where access to information on the partition is enabled.

As an example, a method can include using one or more utilities to create one or more partitions (e.g., fdisk, gparted, etc.). As an example, a method can include creating a file system on a partition (e.g., mkfs command, ext4, default file system, etc.). As an example, a method can include creating a directory to serve as a mount point where a method may mount a partition to the mount point.

As an example, a logical volume manager (LVM) may be utilized where physical volumes (PVs) are disks or partitions that are available to the LVM as potential storage capacity. In such an approach, the PVs can have identifiers and metadata that describes each PV. As opposed to RAID, PVs do not have to be the same size or on disks that are the same speed. As an example, a system may include a number of drive types to create PVs. As an example, a system may include logical volumes (LVs) that can be effectively partitions and, for example, managed akin to partitions. A LV can utilize a file system and a mount point, for example, as may be appropriately configured as explained above (e.g., consider a standard LINUX partition management approach).

As an example, a system may utilize one or more virtual machines and/or one or more other types of virtualizations. A virtual machine (VM) can be utilize a virtual environment that functions as a virtual computing resource, for example, with its own processor, memory, network interface, and storage, created on a physical hardware system. As an example, a hypervisor may be utilized to separate a machine's resources from hardware and to provision resources appropriately for use by one or more VMs. As an example, a VM approach may be utilized for one or more purposes, which may include redundancy, expansion of services on a single field gateway, quality control, testing, etc. As an example, one or more methods may utilize virtualization. As an example, a field gateway may establish a virtual TPM that is compatible with one or more TPM specifications such that a TPM-enabled virtual hardware module is created for use, for example, by a VM. As an example, a kernel-based VM may be utilized for one or more purposes, which may, for example, provide one or more virtual machines with a paravirtualized clock (pvclock), which can provide a stable source of timing for kernel-based VM (KVM) guests. As VMs can have several problems caused by inaccurate clocks and counters such as, for example, clocks falling out of synchronization with actual time (e.g., which may invalidates sessions and affects networks) and VMs with slower clocks that may have issues migrating, a pvclock approach may be utilized. For example, a field gateway may utilize virtualization for one or more purposes where clocking and timing can be stabilized using a pvclock or other suitable approach, for example, for one or more of data acquisition, control, network operations, security, etc. As an example, a pvclock may assist with time adjustments that may be needed after a guest runs a sleep or suspends.

As an example, in a pvclock type of approach, a guest may set aside a page of its RAM and asks a host to write time into that page (e.g., using a model-specific register (MSR)). In such an example, a structure that is written can include the time at the moment it was written, plus the guest's time stamp counter (TSC) at that moment, plus the current scale of TSC to real time (e.g., which can change). In such an example, the guest can read its own TSC a little bit later, work out the difference between TSC now and TSC when the host measured it, scale that to seconds, and add that to the time in the structure to get an estimate of wall clock time. As long as the host does not allow too much time to pass between updates, and does not do something like scale the processor speed or migrate the guest without updating the structure, the guest can get an estimate for wall clock time, optionally without involving a hypervisor.

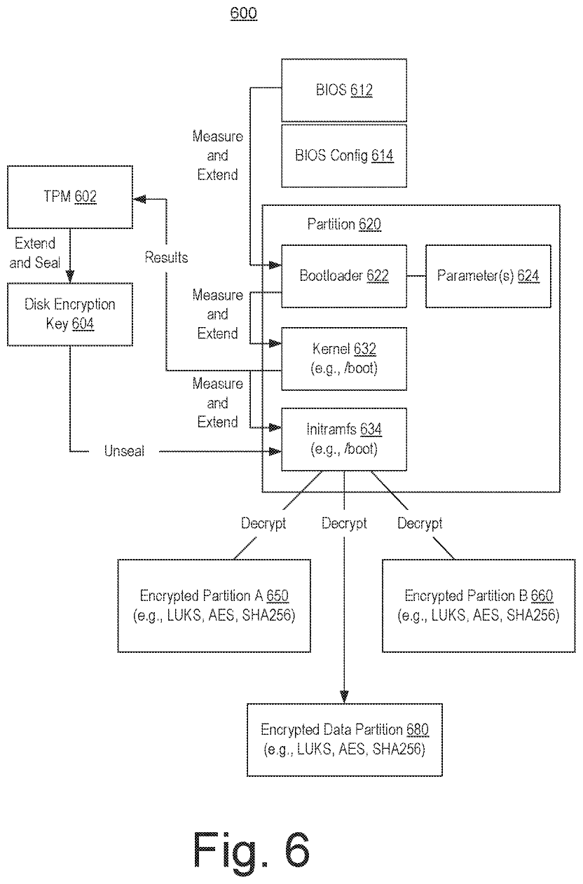

FIG. 6 shows an example of a system 600 along with various processes that can be utilized to assure integrity, data confidentiality and update security with rollback protection. As shown, the system 600 includes a TPM 602 and a disk encryption key 604, as may be provided by the TPM 602. The system 600 shows a series of blocks 612, 614, 622, 624, 632 and 634 as involved in a boot process where interactions with the TPM 602 can occur, for example, for measurements associated with RoT. As shown, measure and extend operations can be performed to provide a result or results that can be assessed by the TPM. As an example, PCRs of the TPM may be utilized to store various values, which can include hashes.

In the example of FIG. 6, the block 612 is a BIOS block and the block 614 is a BIOS configuration block, hence if a BIOS change and/or a BIOS configuration change occurs, a change will occur in a measurement. Hence, tampering and/or other corruption of BIOS or BIOS configuration can be detected.

As to the block 622, it is a bootloader block. A bootloader or boot manager is a relatively small program that performs actions to place an operating system (OS) into memory. For example, when a computing device is powered-up or restarted, BIOS can perform some initial tests and then transfer control to a Master Boot Record (MBR) where the bootloader resides. For LINUX, bootloaders can include one or more of LILO (LInux LOader), LOADLIN (LOAD LINux) and GRUB (GRand Unified Bootloader). As shown in the example of FIG. 6, the bootloader block 622 can include or otherwise operate according to parameters 624. For example, the parameters 624 can include a partition parameter that specifies a particular partition, which may be specified as a location. Thus, if one or more of the parameters 624 are changed for the bootloader block 622, then the measurement in the RoT will change.

As to GRUB, it can be executed in stages where a first stage can utilize a portion of GRUB that resides in the MBR or a boot sector of another partition or drive. As another, main portion of GRUB tends to be too large to fit into a byte limited boot sector (e.g., 512 byte limited, etc.), the first stage can be used to transfer control to a subsequent stage, which may be referred to as a Stage 1.5 or a Stage 2. The Stage 1.5 is loaded by the first stage if hardware requires it. The Stage 1.5 is file system-specific; that is, there is a different version for each file system that GRUB can load. The name of the file system is part of the filename (e2fs_stage1_5, fat_stage1_5, etc.). The Stage 1.5 then loads the Stage 2. The Stage 2 runs the main portion of GRUB, which can provide for selection of an OS to be run, etc., and can then proceed with a process to start the selected OS. If a device name is omitted, a GRUB root device may be assumed where the GRUB root device may be a disk or a partition where a kernel image is stored (e.g., set with a root command). As an example, a system can include multiple OSs, which may include multiple instances of the same OS and/or instances of different OSs. As an example, an update may be provided with an OS, for example, as an OS image along with one or more executables.

As explained, a method can include use of a bootloader configuration that includes one or more parameters that can specify a partition for use when establishing an OS environment where the partition can be one of a number of partitions. As explained, a RoT process can measure code, which can include measuring bootloader code that includes one or more parameters and associated parameter values. Thus, if a change occurs in a bootloader configuration as to a partition, a measurement or result based thereon may differ from a metric stored, for example, in one or more PCRs of a TPM. As an example, a method may perform one or more processes that can account for a change in a bootloader configuration for a system update where the system update is authorized; whereas, an unauthorized attempt to alter a system with an update can result in use of a known good partition and/or known good associated boot components to assure robust operation of the system. In such an approach, non-productive time (NPT) in a field installation may be reduced, for example, as a good partition and/or good components may be utilized to promote robust operation.

In the example of FIG. 6, the block 632 is a kernel block and the block 634 is an initial ram file system (initramfs) block where the blocks 622, 624, 632 and 634 can reside on a common partition 620. As shown, other partitions can include an encrypted partition A 650, an encrypted partition B 660 and an encrypted data partition 680, noting that more partitions may be included.

In context of various operating systems, except those developed by Microsoft Corporation (Redmond, Washington), a system partition and a boot partition are defined as follows: a boot partition is a primary partition that contains the bootloader, a piece of software responsible for booting the operating system (e.g., in the standard LINUX directory layout (Filesystem Hierarchy Standard (FHS)), boot files (such as the kernel, initial ram disk (initrd), and bootloader (GRUB) are mounted at /boot/); and a system partition is the disk partition that includes the operating system folder, known as the system root (e.g., by default, in LINUX, operating system files are mounted at /(the root directory)). As an example, in LINUX, a single partition can be both a boot and a system partition if both /boot/ and the root directory are in the same partition.

In the example of FIG. 6, the kernel block 632 can include a LINUX kernel that can gain control over the system 600 after being loaded by the bootloader block 622 where the kernel block 632 acts to prepare its memory structures and drivers.

In instances where a /usr partition is on a separate file system, tools and drivers that have files stored within /usr cannot be used unless /usr is available. If those tools are needed to make /usr available, then the system cannot boot up. If the root file system is encrypted, then the LINUX kernel will not be able to find the init application, resulting in an unbootable system. One approach to handle this situation is use an initrd (initial root device).

An initrd is an in-memory disk structure (ram disk) that includes appropriate tools and scripts to mount file systems before control is handed over to an init application on a root file system. The LINUX kernel can trigger the setup script (e.g., linuxrc) on this root disk, which prepares the system, switches to the real root file system and then calls init. Although the initrd method can be sufficient, it has a few drawbacks such as it being a full-fledged block device, requiring the overhead of an entire file system (it has a fixed size) and, because it is a real, static device, it consumes cache memory in the LINUX kernel and is prone to the memory and file management methods in use (such as paging), which makes initrd greater in memory consumption. If desired, to address such drawbacks, as an example, an initramfs approach can be utilized.

An initramfs is an initial ram file system based on tmpfs (a size-flexible, in-memory lightweight file system), which does not use a separate block device. Just like the initrd, initramfs includes tools and scripts to mount a file system before an init binary on a real root file system is called. These tools can be decryption abstraction layers (for encrypted file systems), logical volume managers, software raid, BLUETOOTH driver based file system loaders, etc.

The content of the initramfs can be made by creating a cpio archive (e.g., a file archiver utility and its associated file format). Files, tools, libraries, configuration settings (if applicable), etc., can be put into a cpio archive where the archive can be compressed using a utility such as, for example, the gzip utility (e.g., a file format and a software application used for file compression and decompression), and stored alongside the LINUX kernel. In such an example, a bootloader can offer it to the LINUX kernel at boot time so the kernel knows an initramfs is required.

Once the initramfs is detected, a LINUX kernel can create a tmpfs file system, extract the contents of the archive on it, and then launch the init script located in the root of the tmpfs file system. This script can then mount the real root file system (e.g., after making sure it can mount it, for instance by loading additional modules, preparing an encryption abstraction layer, etc.) as well as one or more vital other file systems (e.g., such as /usr and /var).

Once the root file system and the other vital file systems are mounted, the init script from the initramfs can switch the root towards the real root file system and then call the /sbin/init binary on that system to continue the boot process.

In the example of FIG. 6, as shown, if the results of the measurements are acceptable according to the TPM 602, then a disk encryption key 604 is made available for decryption of one or more of the partitions 650, 660 and 680. In the example of FIG. 6, the partitions 650 and 660 can be root file system (rfs) partitions that can be on a common disk and/or on separate disks (see, e.g., examples of partitions above). As explained, in a LINUX based system, LUKS may be utilized in combination with a TPM.

As explained, a system can provide for secure update with rollback protection. In the example of FIG. 6, the use of multiple partitions such as, for example, the partitions 650 and 660, can provide for rollback protection; noting that the bootloader block 622 is to include a parameter in the parameter block 624 to indicate which of the partitions 650 and 660 to utilize where one can be a current partition and where the other can be an updated partition.

As an example, a failsafe software update solution can utilize an A and a B image-based update approach where a system may be updated as a whole rather than incrementally, where a system can dedicate at least two partitions for running the system, where one partition can be an active partition that runs appropriate software and where another partition can be an inactive partition that will be become active after a successful software update.

As an example, during an over-the-air (OTA) update, an active partition (referred as partition A) can be running, and a new software image can be applied to the inactive partition (referred as partition B). After a successful validation of the new image, a bootstrap can set partition B as the next active partition (see, e.g., the parameters block 624). In such an approach, at the next system restart, partition B will become the new active partition and partition A will become the inactive one.

If an error occurs during an update, the active partition will remain unchanged, and the system can rollback to its current working state, as existing prior to the update operation, making the operation failsafe.

As an example, a multi-partition approach can be implemented in a manner that fulfills system integrity protection with HROT requirements and data confidentiality requirements.

As an example, a system can provide a trusted boot design and implementation method and procedures for IIoT gateways to provide system integrity protection based on HROT, data confidentiality protection and reliable/fail-safe system security update mechanism.

As an example, a system can include a security design with: trusted system boot objects to be measured every time the IIoT gateway boots up and those measurements are stored inside a TPM where, during a system boot, if there is software tampering detected, the boot process is halted; a TPM leveraged as a hardware root of trust (HROT) for reporting; full disk encryption enabled for both root file system partitions and data partitions (e.g., on a common disk or on two or more disks); disk encryption key stored inside the TPM and sealed with a known good system state (based on system boot); disk partitions layout to work with trusted system boot and system rollback capability; instructions for a method to detect system boot failure during a software update and fail-safe mechanism to rollback to backup root file system partition and kernel while still maintaining system integrity protection and data confidentiality protection.

As an example, a system can include processes to enable: trusted boot, full disk encryption with encryption key sealed inside a TPM with a known good system measurement; disable trusted boot feature for system maintenance; and prepare software update package for a targeted IIoT gateway which allows system fail-safe rollback in case of an update failure.

As explained with respect to the system 600 of FIG. 6, an IIoT system can provide for integrity and data confidentiality protection. Such a system can measure system boot components (e.g., BIOS, BIOS configuration, bootloader, OS kernel, initrd, initramfs, etc.) where such measurements are recorded into a TPM which is used as a hardware root of trust (HROT) for reporting. Such a system can provide for full disk encryption on a root file system (rootfs or rfs) partition and data partition. Such a system can provide for a disk encryption key stored inside a TPM and protected with a setup of known-good boot component measurements.

As to a system boot up, an initrd and/or initramfs can try to unlock an encryption key from a TPM using system measurements where, if a boot object is tampered with, the process will lead to a different system measurement and initrd and/or initramfs will not have the encryption key to decrypt the encrypted partitions and system boot will be stopped. As an example, a particular case where initrd loads the encryption key in a non-encrypted /boot partition can happens during a system update process where a trusted boot feature is disabled.

As an example, a secure update with fail-safe rollback mechanism can be performed by a system with a tailored partitions layout. For example, consider a layout with unencrypted and boot partitions to keep active and rollback kernel and an initrd file (e.g., or initramfs) where a bootloader is configured to flip back and forth between active and rollback kernel/initrd during a system update status; encrypted active and passive rootfs partitions for a root file system where a bootloader can be configured to flip back and forth between active and passive partitions during a system update status; and encrypted data partition for storage of operational data and persistent system update data and status.

As an example, a system may provide for various workflows to handle different scenarios. For example, consider different modes that can include an IIoT gateway initial setup mode, an IIoT gateway in operation mode, and an IIoT gateway in maintenance/update mode. As an example, an IIoT gateway may include features for monitoring performance of one or more applications where, for example, a trigger or triggers may be issued, which may, for example, call for an update such that an update may be driven by local monitoring. For example, consider a machine learning model (ML model) that may experience some amount of drift where a call can be made for an update to the machine learning model via training, which may include retraining using additional data that are more representative of behavior, conditions, etc., at a field site. As an example, an update cycle may be driven locally and/or remotely where an update can occur in a secure manner that assures system integrity, data confidentiality and rollback where appropriate (e.g., to reduce downtime, NPT, etc.).

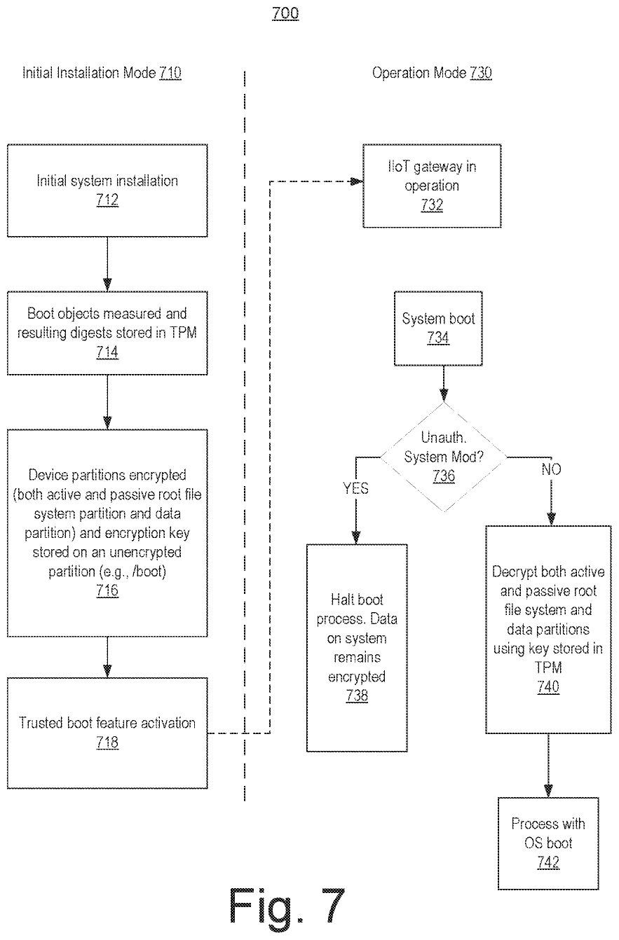

FIG. 7 shows example workflows 700 that include an initial installation mode workflow 710 and an operation mode workflow 730. As shown, an initial system installation block 712 provides for commencing an initial system installation where a measurement block 714 provides for measurement of boot objects and storage of resulting digests in a TPM (e.g., metrics in PCRs). As indicated, a partition block 716 can provide for encrypted active and passive root file partitions (e.g., the partitions 650, 660 and 680 as in the example of FIG. 6) and an encrypted data partition where an encryption key can be stored on an unencrypted partition (e.g., /boot or the partition 620 as in the example of FIG. 6). An activation block 718 can provide for activation of a trusted boot feature.

As to the operation mode workflow 730, an operation block 732 provides for IIoT gateway operation. In various instances at various times, a system boot block 734 may be utilized to perform a system boot. As shown, a decision block 736 decides whether an unauthorized system modification has been detected. As indicated, where such an unauthorized modification has been detected, the operation mode workflow 730 can continue to a halt block 738 that halts the boot process where data on the system remains encrypted. As explained with respect to the example of FIG. 6, various partitions can be encrypted where decryption relies on occurrence of an authorized boot. As indicated, where an unauthorized modification has not been detected, the operation mode workflow 730 can continue to a decryption block 740 where the active and passive root file system and data partitions can be decrypted using a key stored in a TPM (see, e.g., the TPM 602 of FIG. 6). In such an example, the operation block 732 can proceed with processing of an OS boot.

As explained, an IIoT gateway initial setup mode can be implemented where, during an OS installation (instantiation) boot object measurements are recorded to TPM PCRs along a chain from BIOS to an OS kernel. These measurements depend on boot object state and configuration. As an example, configuration measurements may or may not be accounted for during boot control, depending on implementation specifics. As to an OS root partition, as with other data partitions, it can be encrypted during an initial installation. In such an example, an encryption key can be generated randomly and stored, for example, in plain text on a partition, which is not encrypted.

As indicated in FIG. 7, the block 718 can activate a trusted boot feature at the end of an initial system setup process. Such a feature can store a disk encryption key into a TPM and seal it with the current TPM PCRs values, and shred the plain text key from the partition. The block 718 can be a task that completes a system initial set up such that an IIoT gateway can move the IIoT gateway to operation mode.

As to the IIoT gateway in operation mode, during a system boot process, the measurement of each boot component (e.g., BIOS, BIOS configuration, boot loader, OS kernel, etc.) can be recorded into TPM PCRs. In such an example, the initrd (or initramfs) will try to unlock the disk encryption key from the TPM using the current system measurements (see, e.g., FIG. 6). In such an approach, if there is an unauthorized change to one or more of the system boot components, the disk encryption key cannot be unlocked, and system boot is halted, as indicated in the halt block 738. As explained, where measurements are proper, once the initrd (or initramfs) has the disk encryption key, initrd (or initramfs) can decrypt an active rootfs partition, a passive rootfs partition and one or more data partitions. In such an example, once the OS is fully loaded (e.g., an OS environment fully established), the data encryption/decryption is fully transparent to one or more applications and services running at the OS level.

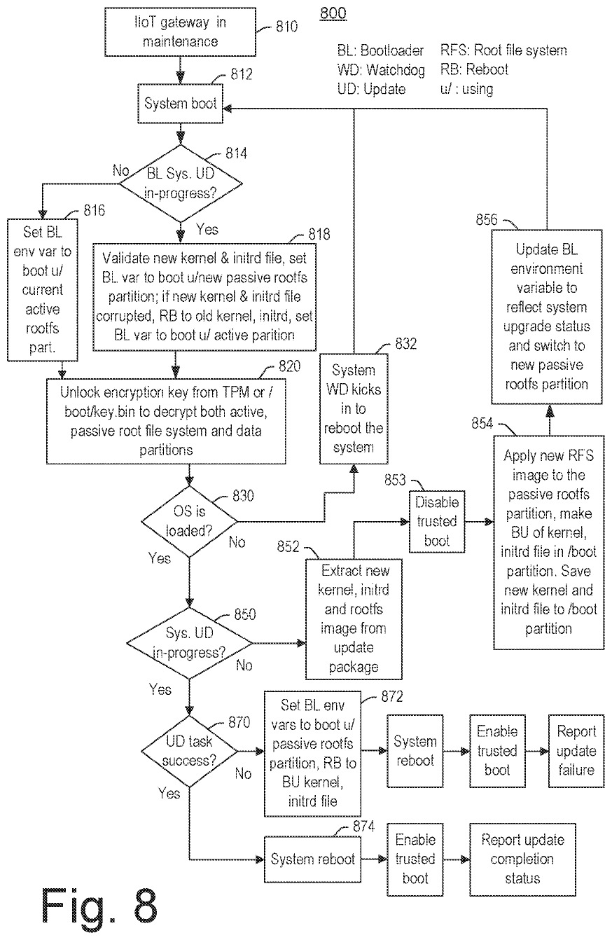

FIG. 8 shows an example of an IIoT gateway maintenance mode workflow 800 that commences in a maintenance block 810 that proceeds to a system boot 812 where a decision block 814 decides via a bootloader (BL) if a system update (UD) is in progress. Per a “no” branch, a set block 816 can set a bootloader environment variable to boot using the current active rootfs partition; whereas, per a “yes” branch, a validation block 818 can validate a new kernel and initrd file (or initramfs), and set a bootloader variable to boot using the new passive rootfs partition. In such an example, if the new kernel and/or the initrd file (or initramfs) are corrupted, the maintenance mode workflow 800 can rollback (RB) to the old kernel and initrd (or initramfs) and set a bootloader variable to boot using the active partition.

As shown, from either branch, the workflow 800 can proceed to an unlock block 820 for unlocking an encryption key from a TPM or a /boot/key.bin to decrypt active and passive root file systems and one or more data partitions. As shown, a series of decision blocks 830, 850 and 870 can follow where each of the decision blocks 830, 850 and 870 includes “no” and “yes” branches and where the “yes” branch of the decision block 830 causes the workflow 800 to proceed to the decision block 850 and where the “yes” branch of the decision block 850 causes the workflow to proceed to the decision block 870. As shown, the “no” branch of the decision block 830 indicates that the OS is not loaded such that a system watchdog (WD) block 832 causes the system WD to kick in to reboot the system where the system WD block 832 can continue to the system boot block 812.

As explained, the decision block 850 can follow the “yes” branch of the decision block 830. The decision block 850 determines whether a system update (UD) is in progress where, if not, per the “no” branch, the workflow 800 proceeds to an extraction block 852 that extracts the new kernel, initrd (or initramfs) and/or rootfs image from an update package. As an example, a maintenance mode workflow can accommodate an update to a kernel, an initrd (or initramfs) and/or a rootfs image. In the example of FIG. 8, the workflow 800 can continue from the extraction block 852 to a disable block 853 that can disable a trusted boot feature such that an application block 854 can apply a new root file system (RFS or rootfs or rfs) image to the passive rootfs partition and make a backup (BU) of the kernel and the initrd file (or initramfs) in the /boot partition (see, e.g., the partition 620 of FIG. 6) where the workflow 800 can save the new kernel and initrd file (or initramfs) to the /boot partition. In such an example, an update block 856 can update the bootloader (BL) environment variable to reflect the system upgrade status and switch to the new passive rootfs partition. As shown, the workflow 800 can then proceed to the system boot block 812.

As explained, the decision block 870 can follow the “yes” branch of the decision block 850. The decision block 870 determines whether a system update is successful where, per the “yes” branch, the workflow 800 can proceed to a system reboot block 874 that can provide for enabling trusted boot and reporting on completion of the update (e.g., update completion status). As to the “no” branch, the workflow 800 can enter a set block 872 that sets bootloader environment variable to boot using the passive rootfs partition and to rollback to the backup kernel and initrd file (or initramfs). As indicated, the workflow 800 can proceed to a system reboot block, enabled trusted boot and report an update failure. As explained, the decision block 870 can handle scenarios where an update is successful or unsuccessful where operation of an IIoT gateway can be practically uninterrupted such that downtime (e.g., NPT) does not occur or is otherwise minimal.

As explained, at system boot, a bootloader can check one or more environment variables to determine if there is a system update in progress where, if there is no “in-progress” update, the bootloader can use the active rootfs partition to boot. However, if there is an “in-progress” update, the bootloader can use the new kernel and initrd file (or initramfs) and the passive rootfs partition to boot. If there is an issue to boot using the new updated kernel and initrd file (or initramfs) and the new rootfs partition, the bootloader can reset one or more of the environment variables to use a previous partition and previous kernel and initrd file (or initramfs) on the next reboot. In the example of FIG. 8, encrypted partitions may be decrypted by initrd (or initramfs) by using a key from a TPM or a copy of the key stored on an unencrypted boot partition (e.g., /boot).

As an example, when an OS is fully loaded, data encryption/decryption tasks can be totally transparent to applications running at the OS level. In such an example, a workflow can check if there is a system update in-progress where, if there no in-progress system update, the workflow can extract a new kernel, initrd (or initramfs) and/or rootfs image from a software update package and disable trusted boot on the system, which provides for extraction of the disk encryption key from a TPM and storage of the key on unencrypted boot partition. In such an example, a backup of the current kernel and initrd (or initramfs) can be saved along with the new kernel and initrd file (or initramfs) to /boot (e.g., the boot partition). In such an approach, a workflow can apply the new rootfs image to the passive rootfs partition and one or more bootloader environment variables can be updated to reflect the system update in-progress status and switch to the new passive rootfs partition on the next reboot.

However, if there is in-progress system update, then a workflow can validate whether or not an update task was successful. In such an example, if the task was unsuccessful, a workflow can set a bootloader environment variable to use the previous rootfs partition while also rolling back to the backup kernel and initrd file (or initramfs). The workflow can then reboot the system and re-enable trusted boot and report the system update failure. In the instance that the task was successful, a workflow can reboot the system, re-enable trusted boot and report the system update completion status.

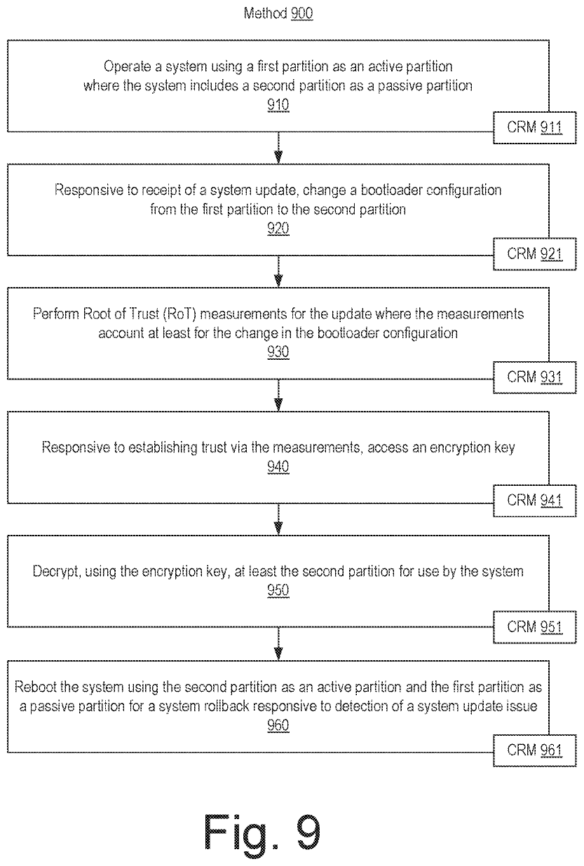

FIG. 9 shows an example of a method 900 that includes an operation block 910 for operating a system using a first partition as an active partition and a second partition as a passive partition; a change block 920 for, responsive to receipt of a system update, changing a bootloader configuration from the first partition to the second partition; a performance block 930 for performing root of trust measurements for the update where the measurements account at least for the change in the bootloader configuration; an access block 940 for, responsive to establishing trust via the measurements, accessing an encryption key; a decryption block 950 for decrypting, using the encryption key, at least the second partition for use by the system; and a reboot block 960 for rebooting the system using the second partition as an active partition and the first partition as a passive partition, for example, for a system rollback responsive to detection of a system update issue.

FIG. 9 also shows various computer-readable media (CRM) blocks 911, 921, 931, 941, 951, and 961. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

As explained, a system can include features for a failsafe attribute of an update. Such a system can provide a reliable rollback mechanism. As explained, adding file system encryption and allowing update of components that can perform the decryption can result in severe consequences for operations if not executed properly. As explained, a method can help to guarantee that a system ends up with being a functional system in view of reasonable operating conditions.

As explained, a TPM can be utilized to perform a RoT process (e.g., a root of trust measurement (RTM) process) that measures at least a bootloader configuration that can specify a partition amongst multiple partitions. Such an RoT process can measure each boot object in a boot chain from BIOS, BIOS configuration, bootloader binary, bootloader configuration, kernel and initramfs (e.g., or initrd, etc.).

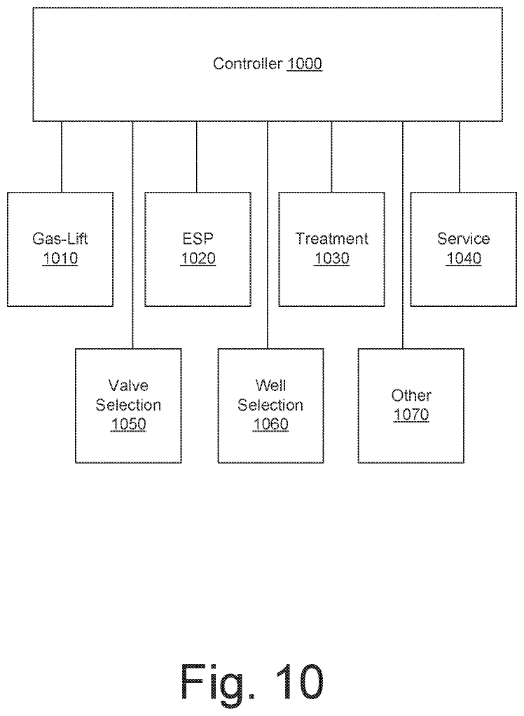

FIG. 10 shows an example of a controller 1000 that can be part of a field system. In the example of FIG. 10, the controller 1000 can include one or more components such as, for example, one or more of a gas lift component 1010, an electric submersible pump component 1020, a treatment component 1030, a service component 1040, a valve selection component 1050, a well selection component 1060 and one or more other components 1070. As explained, information gleaned via control such as according to one or more methods may be utilized to determine one or more actions that may aim to improve production, improve operation of equipment (e.g., valves, flow meters, etc.), improve utilization of one or more resources (e.g., gas, electricity for an ESP, chemical injection, etc.).

As an example, the controller 1000 can include one or more features of the system 400 of FIG. 4 where one or more workflows may be performed such as, for example, one or more of the workflows of FIG. 7 and FIG. 8 and/or the method 900 of FIG. 9.

As an example, a method can include operating a field system using a first partition as an active partition and a second partition as a passive partition; responsive to receipt of a system update, changing a bootloader configuration from the first partition to the second partition; performing root of trust measurements for the update where the measurements account at least for the change in the bootloader configuration; responsive to establishing trust via the measurements, accessing an encryption key; decrypting, using the encryption key, at least the second partition for use by the system; and rebooting the field system using the second partition as an active partition and the first partition as a passive partition for a system rollback responsive to detection of a system update issue. In such an example, the method can include, responsive to a system update issue, changing the bootloader configuration from the second partition to the first partition. For example, consider a system update issue as may be associated with tampering, corruption, etc., of one or more components of a system update. In such an example, the first partition can be a fallback partition that once again becomes an active partition. Such an approach can provide for more robust field operations of a field system where field system integrity and information confidentiality can be maintained. As explained, a field system such as, for example, a field gateway, can include features that provide for system integrity, information confidentiality and update security with a fail-safe rollback mechanism.

As an example, a method can include performing root of trust measurements using a trusted platform module.

As an example, a field system can include various partitions, which can include a data partition. As explained, one or more partitions can be secured via encryption, which may utilize one or more encryption keys as may include one or more TPM encryption keys (e.g., TPM stored, generated, etc.).

As an example, a field system can include a boot partition that stores at least a bootloader. As an example, a system update can include an update for one or more of BIOS, a bootloader, an operating system kernel, an initial file, and an application.

As an example, a method can include extracting one or more of a kernel, an initial file and a root file system image from a system update. In such an example, a method can include applying the root file system image to a second partition, storing a backup of an existing kernel to a boot partition and saving the kernel of the system update to the boot partition.

As an example, a bootloader configuration can include a variable that specifies a boot partition or boot device. For example, consider a variable that indicates an active partition for purposes of booting, where a passive partition can be maintained, for example, as a fallback partition for purposes of a rollback that may be triggered by detection of one or more events (e.g., one or more system update issues, etc.). As an example, a method can include, responsive to a lack of trust, operating the system using a first partition as an active partition where, for example, the first partition was previously a passive partition.

As an example, a method can include accessing an encryption key from a trusted platform module and/or from a bin file.

As an example, a method can include enabling a trusted boot feature after rebooting the field system.

As an example, a field system can include satellite communication circuitry where, for example, a method can include receiving a system update via the satellite communication circuitry.

As an example, a field system can be operatively coupled to one or more pieces of equipment at a wellsite where, for example, a system update may include instructions for control of at least one of the one or more pieces of equipment at the wellsite.

As an example, a system can include one or more processors; memory accessible to at least one of the one or more processors; processor-executable instructions stored in the memory and executable to instruct the system to: operate a field system using a first partition as an active partition and a second partition as a passive partition; responsive to receipt of a system update, change a bootloader configuration from the first partition to the second partition; perform root of trust measurements for the update where the measurements account at least for the change in the bootloader configuration; responsive to establishment of trust, access an encryption key; decrypt, using the encryption key, at least the second partition for use by the system; and reboot the field system using the second partition as an active partition and the first partition as a passive partition for a system rollback responsive to detection of a system update issue.

As an example, one or more computer-readable storage media can include processor-executable instructions to instruct a computing system to: operate a field system using a first partition as an active partition and a second partition as a passive partition; responsive to receipt of a system update, change a bootloader configuration from the first partition to the second partition; perform root of trust measurements for the update where the measurements account at least for the change in the bootloader configuration; responsive to establishment of trust, access an encryption key; decrypt, using the encryption key, at least the second partition for use by the system; and reboot the field system using the second partition as an active partition and the first partition as a passive partition for a system rollback responsive to detection of a system update issue.

As an example, a computer program product can include one or more computer-readable storage media that can include processor-executable instructions to instruct a computing system to perform one or more methods and/or one or more portions of a method.

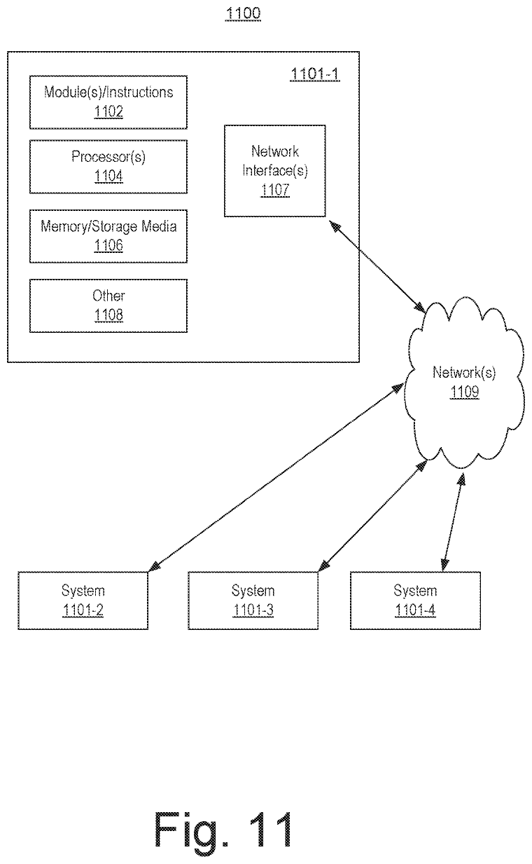

In some embodiments, a method or methods may be executed by a computing system. FIG. 11 shows an example of a system 1100 that can include one or more computing systems 1101-1, 1101-2, 1101-3 and 1101-4, which may be operatively coupled via one or more networks 1109, which may include wired and/or wireless networks.

As an example, a system can include an individual computer system or an arrangement of distributed computer systems. In the example of FIG. 11, the computer system 1101-1 can include one or more modules 1102, which may be or include processor-executable instructions, for example, executable to perform various tasks (e.g., receiving information, requesting information, processing information, simulation, outputting information, etc.).

As an example, a module may be executed independently, or in coordination with, one or more processors 1104, which is (or are) operatively coupled to one or more storage media 1106 (e.g., via wire, wirelessly, etc.). As an example, one or more of the one or more processors 1104 can be operatively coupled to at least one of one or more network interfaces 1107; noting that one or more other components 1108 may also be included. In such an example, the computer system 1101-1 can transmit and/or receive information, for example, via the one or more networks 1109 (e.g., consider one or more of the Internet, a private network, a cellular network, a satellite network, etc.).

As an example, the computer system 1101-1 may receive from and/or transmit information to one or more other devices, which may be or include, for example, one or more of the computer systems 1101-2, etc. A device may be located in a physical location that differs from that of the computer system 1101-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1406 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
operating a field system using a first partition as an active partition and a second partition as a passive partition;
responsive to receipt of a system update, changing a bootloader configuration from the first partition to the second partition;
performing root of trust measurements for the update where the measurements account at least for the change in the bootloader configuration;
responsive to establishing trust via the measurements, accessing an encryption key;
decrypting, using the encryption key, at least the second partition for use by the system; and
rebooting the field system using the second partition as an active partition and the first partition as a passive partition for a system rollback responsive to detection of a system update issue.

2. The method of claim 1, comprising, responsive to a system update issue, changing the bootloader configuration from the second partition to the first partition.

3. The method of claim 2, wherein performing root of trust measurements comprises using a trusted platform module.

4. The method of claim 1, wherein the field system comprises a data partition.

5. The method of claim 1, wherein the field system comprises a boot partition that stores at least the bootloader.

6. The method of claim 1, wherein the system update comprises an update for one or more of BIOS, a bootloader, an operating system kernel, an initial file, and an application.

7. The method of claim 1, comprising extracting one or more of a kernel, an initial file and a root file system image from the system update, and optionally comprising applying the root file system image to the second partition and/or storing a backup of an existing kernel to a boot partition and saving the kernel of the system update to the boot partition.

8. The method of claim 1, wherein the bootloader configuration comprises a variable that specifies a boot partition or boot device.

9. The method of claim 1, comprising responsive to a lack of trust, operating the field system using the first partition as the active partition.

10. The method of claim 1, wherein accessing the encryption key accesses the encryption key from a trusted platform module or accesses the encryption key from a bin file.

11. The method of claim 1, comprising enabling a trusted boot feature after rebooting the field system.

12. The method of claim 1, wherein the field system comprises satellite communication circuitry and optionally comprising receiving the system update via the satellite communication circuitry.

13. The method of claim 1, wherein the field system is operatively coupled to one or more pieces of equipment at a wellsite, optionally wherein the system update comprises instructions for control of at least one of the one or more pieces of equipment at the wellsite.

14. A system comprising:
one or more processors;
memory accessible to at least one of the one or more processors;
processor-executable instructions stored in the memory and executable to instruct the system to:
operate a field system using a first partition as an active partition and a second partition as a passive partition;
responsive to receipt of a system update, change a bootloader configuration from the first partition to the second partition;
perform root of trust measurements for the update where the measurements account at least for the change in the bootloader configuration;
responsive to establishment of trust via the measurements, access an encryption key;
decrypt, using the encryption key, at least the second partition for use by the system; and
reboot the field system using the second partition as an active partition and the first partition as a passive partition for a system rollback responsive to detection of a system update issue.

15. The system of claim 14, comprising, responsive to a system update issue, changing the bootloader configuration from the second partition to the first partition.

16. The system of claim 14, wherein performing root of trust measurements comprises using a trusted platform module and wherein the field system comprises a boot partition that stores at least the bootloader.

17. The system of claim 14, wherein the system update comprises an update for one or more of BIOS, a bootloader, an operating system kernel, an initial file, and an application.

18. The system of claim 14, comprising extracting one or more of a kernel, an initial file and a root file system image from the system update, and optionally comprising applying the root file system image to the second partition and/or storing a backup of an existing kernel to a boot partition and saving the kernel of the system update to the boot partition.

19. The system of claim 14, wherein the field system comprises satellite communication circuitry and optionally comprising receiving the system update via the satellite communication circuitry.

20. A non-transitory computer readable storage medium storing instructions that when executed by a computer, which includes a processor performs a method, the method comprising:
operating a field system using a first partition as an active partition and a second partition as a passive partition;
responsive to receipt of a system update, changing a bootloader configuration from the first partition to the second partition;
performing root of trust measurements for the update where the measurements account at least for the change in the bootloader configuration;
responsive to establishing trust via the measurements, accessing an encryption key;
decrypting, using the encryption key, at least the second partition for use by the system; and
rebooting the field system using the second partition as an active partition and the first partition as a passive partition for a system rollback responsive to detection of a system update issue.
